(19) United States
(12) Patent Application Publication
(10) Pub. No.: US 2003/0067784 A1
(43) Pub. Date: Apr. 10, 2003

(54) Reflector for a light assembly, such as a taillight, a headlight, or an interior light, of a motor vehicle

(75) Inventor: Andreas Erber, Ostfildern (DE)

Correspondence Address: GUDRUN E. HUCKETT, LONSSTR. 53, WUPPERTAL, 42289, DE

(73) Assignee: Schefenacker Visions Systems Germany GmbH & Co. KG, Esslingen (DE)

(21) Appl. No.: 10/065,328

(22) Filed: Oct. 4, 2002

(30) Foreign Application Priority Data
Oct. 5, 2001 (DE) 10149273.1

(51) Int. Cl. F 21W 1 1/00

(52) U.S. Cl. 362/516

(57) ABSTRACT

A reflector for a light assembly of a motor vehicle has at least one reflector surface for rays emitted by an illumination element positioned at a spacing to the at least one reflector surface. The at least one reflector surface is a surface of revolution whose generatrix is part of a curve and ascends in a direction to the illumination element that is oriented toward the at least one reflector surface. The curve can be a parabola, an ellipse or a free-form curve.

### BACKGROUND OF INVENTION

1. Field of the Invention

The invention relates to a reflector for a light assembly, such as a taillight, a headlight, or an interior light, of a motor vehicle, wherein the reflector comprises at least one reflector surface for rays emitted by an illumination element positioned at a spacing to the reflector surface.

2. Description of the Related Art

Light assemblies, for example, headlight units, are known in which an illumination element is arranged in a housing behind a lens whose light is reflected by a reflector onto the lens. Such light assemblies require a large mounting space. Moreover, the reflector surfaces of such light assemblies present problems in regard to vapor deposition. Moreover, the light emission surface for a predetermined mounting depth of the light assembly cannot be made as large as desired so that in such cases several illumination elements are required.

### SUMMARY OF INVENTION

It is an object of the present invention to configure a reflector of the aforementioned kind such that with a minimal mounting height an illuminated surface as large as possible can be achieved.

In accordance with the present invention, this is achieved in that the reflector surface is a surface of revolution whose generatrix is part of a curve and ascends in the direction toward the illumination element which illumination element is oriented toward the reflector surface.

The curve can be a parabola, an ellipse or a free-form curve.

As a result of the configuration according to the invention, the reflector surface ascends in the direction toward the illumination element. In this way, the illumination element can be arranged relatively closely to the reflector surface. The light which is emitted by the illumination element impinges completely on the reflector surface and can be utilized in a targeted way for light distribution. A preferred embodiment of an illumination element is an LED. A single LED is sufficient in order to obtain a large illuminated surface area. The light provided with the reflector according to the invention has only a minimal mounting depth because the illumination element is arranged at a minimal spacing relative to the reflector surface.

### BRIEF DESCRIPTION OF DRAWINGS

FIG. 1 is a schematic simplified illustration of a part of a first reflector according to the invention in axial section.

FIG. 2 is a schematic simplified illustration of a part of a second reflector according to the invention in axial section.

FIG. 3 is a schematic simplified illustration of a part of a third reflector according to the invention in axial section.

FIG. 4 is a schematic simplified illustration of a part of a fourth reflector according to the invention in axial section.

FIG. 5a schematic simplified illustration of a part of a fifth reflector according to the invention in axial section.

FIG. 6 shows the reflector of FIG. 1 in a perspective illustration.

### DETAILED DESCRIPTION

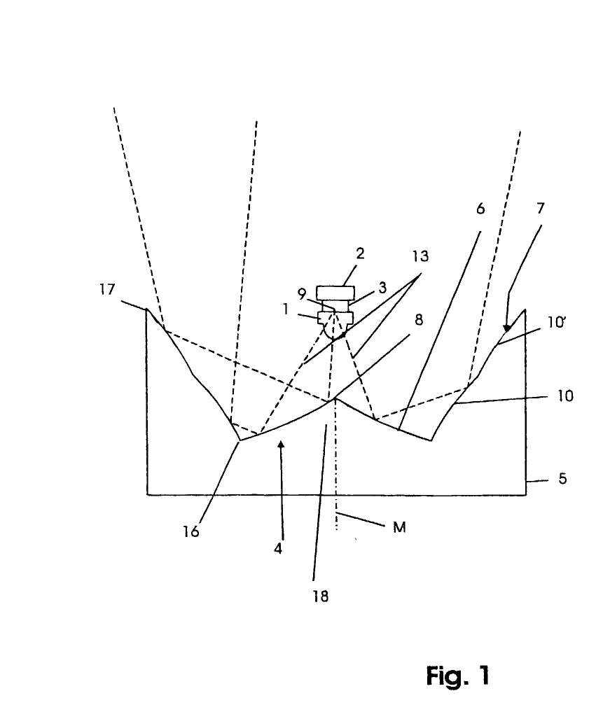

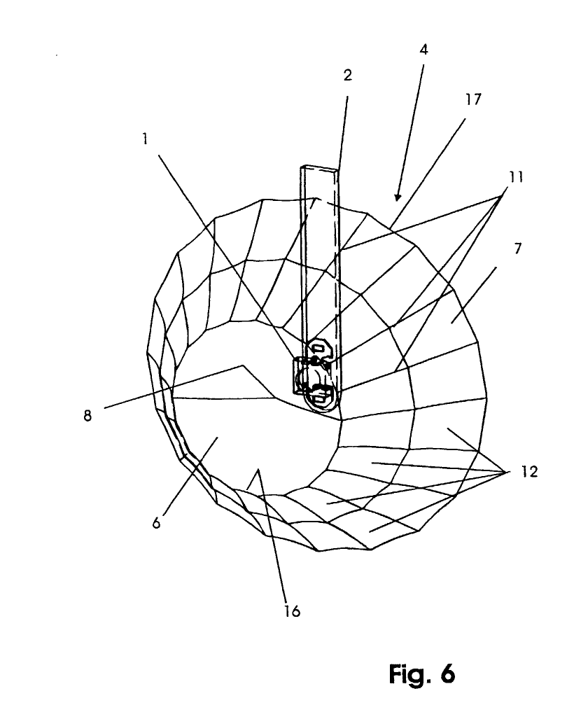

FIGS. 1 and 6 show a reflector for a light assembly, in particular, for a headlight of motor vehicles. The reflector has an annular body 5 of which FIG. 1 shows only one part. The housing (not illustrated) which receives the reflector has a housing opening which is covered by a lens (also not illustrated). Within the annular body 5 an illumination element in the form of an LED 1 is arranged which is fastened on the support 2 by means of a securing leg 3. The LED 1 is arranged at a spacing in front of a reflector 4 which is part of the annular body 5.

The support 2 of the LED 1 is preferably embodied as an elongated stay (FIG. 6) comprised of a transparent plastic material and provided with conductors for supplying electrical current.

The reflector 4 has an inner reflector surface 6 which is formed as an exterior side of a body of revolution 18 whose generatrix is a part of a parabola rotated about a centerline M. The resulting body of revolution 18 has a tip 8 positioned on the centerline M. The focal point 9 of the reflector 4 or of the body of revolution 18 is also positioned on the centerline M. The reflector surface 6 in axial section is concavely curved.

An outer reflector part 7 adjoins the reflector surface 6 and extends about the circumference of the reflector 4 and widens in the outward direction. The reflector part 7 is divided into two adjoining annual parts 10, 10′ which are each comprised of cushion-shaped reflector sections 12. The reflector sections 12 within one annular part 10, 10′ are advantageously of the same size (FIG. 6) and adjoin one another. The reflector sections 12 of the annular part 10 are advantageously of the same size as the reflector sections 12 of the annular part 10′. In a plan view, the reflector sections 12 have a rectangular contour. The reflector sections 12 within the two annular parts 10, 10′ are positioned sequentially in the direction of height of the reflector 4. In this way, grooves 11 (FIG. 6) are provided between the reflector sections which, in a plan view onto the reflector 4, extend straight from the rim 16 of the reflector surface 6 to the outer edge 17 of the reflector 4. The outer reflector part 7 projects past the tip of the inner reflector body 18 and the LED 1.

The reflector 4 is embodied such that the rays 13 emitted by the LED 1 are completely received by it and used for light distribution. The light rays 13 which extends divergingly away from the LED 1 impinge first on the reflector surface 6. The reflector surface 6 reflects the light rays 13 to the reflector part 7 where they are reflected outwardly to the lens (not illustrated). The light rays 13 are scattered on the cushion-shaped reflector sections 12. It is also possible to configure the outer reflector part 7 as a conical part. Because no scattering optics, such as the reflector sections 12, are provided, the light 13 is reflected in this case to the exterior as a parallel light bundle.

As a result of the describe configuration, it is achieved that the light assembly comprising only a single LED 1 has a very minimal mounting depth and provides a large illuminated surface. The described reflector 4 can be used for all kinds of illumination purposes such as motor vehicle taillights, motor vehicle headlights, motor vehicle interior lights as well as illumination devices of all kinds.

Instead of the cushion-shaped reflector sections 12, scatter optics in the form of roller-shaped reflector sections or any other suitably configured reflector sections can be used within the outer reflector part 7. In this case, the lens does not have to provide a scattering function for the light and can therefore be embodied as a simple inexpensive lens.

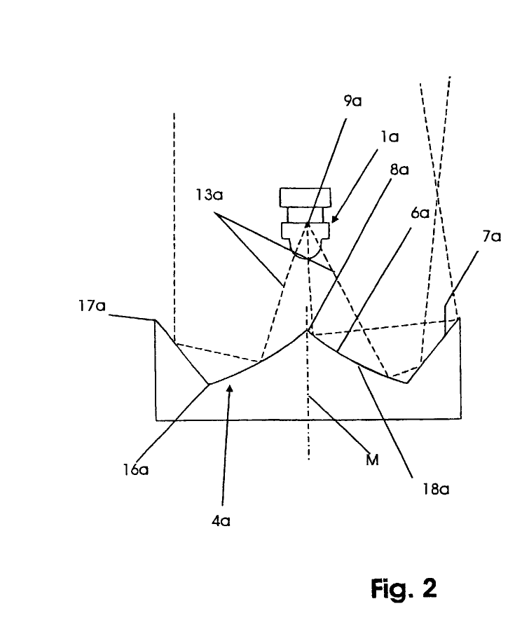

In the embodiment according to FIG. 2, the body of revolution 18a comprising the reflector surface 6a has a generatrix which is part of an ellipse rotated about the centerline M. The outer reflector part 7a has a reflector surface positioned on a conical mantle surface which extends from the outer rim 16a of the reflector surface 6a of the reflector 4a to the outer edge 17a of the reflector part 7a. In accordance with the preceding embodiment, the tip 8a is positioned at the center of the body of revolution 18a of the reflector 4a. The reflector surface 6a viewed in axial section is concavely curved.

As in the preceding embodiment the reflector surfaces 6a of the body of revolution 18a and the reflector surface of the reflector part 7a are arranged relative to one another such that the light rays 13 emitted by the LED 1a impinge on the reflector surface 6a and are reflected thereat toward the outer reflector part 7a which, in turn, reflects them onto the lens. The embodiment of the reflector surface 6a determines the resulting scattering. Alternatively, the reflector part 7a can be provided additionally with scattering optics.

The outer reflector part 7a has a smaller axial extension than the reflector part 7 and extends up to approximately the level of the tip 8a. Since the reflector part 7a has no scattering function, the lens (not illustrated) of the light assembly is provided with a scattering optic. The LED 1a is arranged, as in the preceding embodiment, such that its focal point is within the focal point 9a of the body of revolution 18a. The LED 1a is positioned within a focal point outside of the reflector 4a.

It is also possible that the reflector surface 6a as well as the reflector part 7a each fulfill a scattering function and are provided with scattering optics, e.g., those described above.

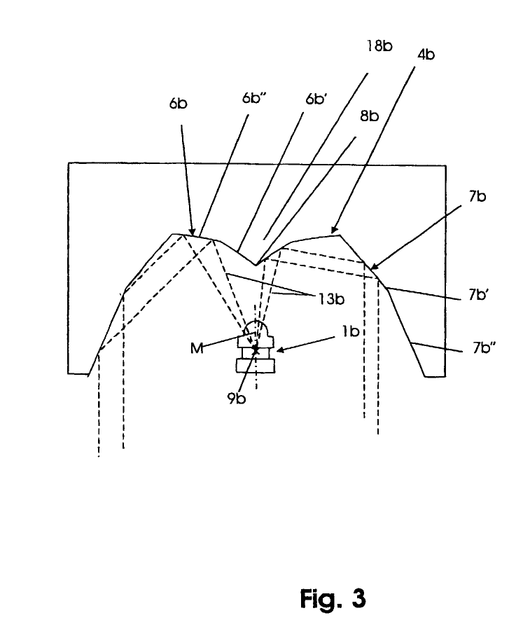

In the reflector 4b according to FIG. 3 the reflector surface 6b of the body of revolution 18b has two adjoining annular zones 6b′ and 6b″, wherein their generatrix is a part of a parabola, respectively. The parabola parts are differently inclined. The radially inwardly positioned parabola part (annular zone 6b′) extends more steeply than the outer parabola part (annular zone 6b″). The body of revolution 18b has a central tip 8b positioned, like the focal point 9b of the reflector 4b, on the centerline M. The outer reflector part 7b is comprised also of two annular zones 7b′ and 7b″ adjoining one another and each having a conical mantle surface as a reflector surface. The outer conical mantle surface (annular zone 7b″) extends more steeply than the inner conical mantle surface (annular zone 7b′). The annular zones 7b′, 7b″ can be provided with cushion-shaped, roller-shaped or any other type of suitable scattering optics. The LED 1b is positioned, as in the embodiment of FIG. 1, within the reflector 4b.

The light rays 13b emitted by the LED 1b reach the reflector surfaces of the annular zones 6b′, 6b″ where they are reflected onto the reflector surfaces of the annular zones 7b′, 7b″. Here the light rays 13b are reflected parallel to one another and to the centerline M out of the reflector 4b to the lens of the respective light assembly. The annular zone 6b′ is correlated with the annular zone 7b′ and the annular zone 6b″ is correlated with the annular zone 7b″.

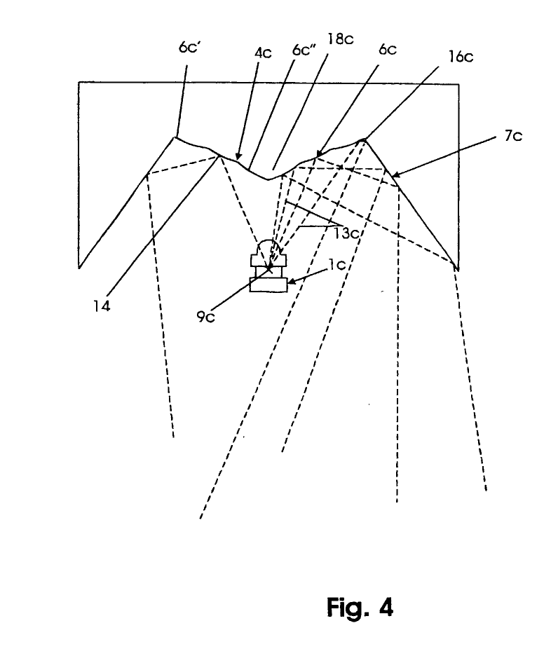

In the reflector 4c according to FIG. 4, the central body of revolution 18c is provided with the scattering optics 6c′, 6c″, 14 which are preferably cushion-shaped optics and are positioned on parabolas, respectively. A conical mantle surface of the outer reflector part 7c adjoins the circumferential outer rim 16c of the body of revolution 18c. The conical mantle surface can be provided with a scattering optic. The reflector part 7, as in the embodiment of FIG. 1, has a substantially greater axial extension than the body of revolution 18c. The focal point 9c of the reflector 4c in this embodiment also coincides with the focal point of the LED 1c. The diverging rays 13c emitted by the LED 1c are reflected on the reflector surfaces 6c of the body of revolution 18 to the conical mantle surface of the reflector part 7c where they are reflected to the exterior. The LED 1c is positioned centrally within the annular reflector 4c.

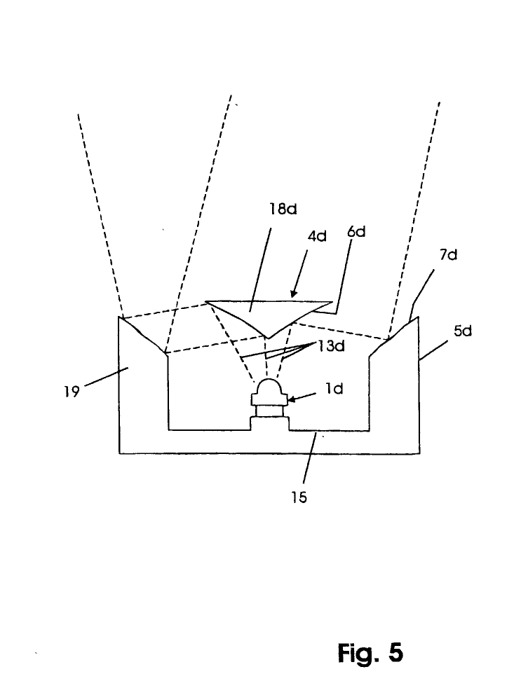

In the embodiment according to FIG. 5, the LED 1d is arranged in the area between a back wall 15 and the body of revolution 18d which is of identical configuration as the body of revolution 18 of FIG. 1. The LED 1d is fastened on the back wall 15. The light rays 13d emitted by the LED 1d impinge on the reflector surface 6d of the body of revolution 18d where the light rays are reflected onto the outer reflector part 7d. It is a part of an annual wall 19 of the annular body 5d and has a reflector surface located on the conical mantle surface. On it the light rays are reflected onto the lens (not illustrated). In the reflector surface of the outer reflector part 7d, as in the embodiment, scattering optics can be provided. The LED 1d is positioned centrally in the housing 5d. The body of revolution 18d projects partially into the space surrounded by the annular wall 19. The body of revolution 18d is configured and arranged such that all light rays 13d impinging on its reflector surface 6d are reflected to the outer reflector part 7d. The LED 1d is covered by the body of revolution 18d relative to the lens. In this way, the light emitted by the LED does not directly reach the lens so that high luminance and glare correlated therewith are prevented. The body of revolution 18d can also be provided on the lens, preferably, as a unitary part thereof.

In the described embodiments, all of the light emitted by the LED is completely received and utilized in a targeted way for light distribution. The body of revolution, respectively, can be viewed as an outwardly turned paraboloid or ellipsoid which shapes the diverging LED light to a preferably parallel or diverging bundle of rays directed outwardly. By means of additional reflector surfaces on the reflector parts 7 to 7c the light is deflected into the final emission direction. As a result of the described embodiment of the reflectors a high luminance of the LED light source which has high luminance and is approximately point-shaped is prevented.

In deviation from the illustrated embodiments, the illumination element can be positioned also directly on the lens.

While specific embodiments of the invention have been shown and described in detail to illustrate the inventive principles, it will be understood that the invention may be embodied otherwise without departing from such principles.

What is claimed is:

1. A reflector for a light assembly of a motor vehicle, the reflector comprising at least one reflector surface (6, 6a to 6d) for rays emitted by an illumination element (1, 1a to 1d) positioned at a spacing to the at least one reflector surface, wherein the at least one reflector surface (6, 6a to 6d) is a surface of revolution whose generatrix is part of a curve and ascends in a direction to the illumination element (1, 1a to 1d) oriented toward the at least one reflector surface (6, 6a to 6d).

2. The reflector according to claim 1, wherein the curve is a part of a parabola.

3. The reflector according to claim 1, wherein the curve is a part of an ellipse.

4. The reflector according to claim 1, wherein the curve has a free-form course.

5. The reflector according to claim 1, wherein the at least one reflector surface (6, 6a to 6d) is provided centrally with a tip (8, 8a, 8b) oriented toward the illumination element (1, 1a to 1d).

6. The reflector according to clean 1, wherein a focal point (9) of the illumination element (1, 1a to 1d) coincides substantially with a focal point of the at least one reflector surface (6, 6a to 6d).

7. The reflector according to claim 1, further comprising an outer reflector part (7, 7a to 7c), wherein the at least one reflector surface (6, 6a to 6d) is surrounded by the outer reflector part (7, 7a to 7c).

8. The reflector according to claim 7, wherein the outer reflector part (7, 7a to 7c) adjoins the at least one reflector surface (6, 6a to 6c).

9. The reflector according to claim 7, wherein the outer reflector part (7, 7a to 7c) projects past the at least one reflector surface (6, 6a to 6c) in an axial direction of the reflector (4, 4a to 4c).

10. The reflector according to claim 1, wherein the at least one reflector surface (6b) has at least two annular zones (6b′, 6b″) adjoining one another.

11. The reflector according to claim 10, wherein the generatrix of each one of the at least two annular zones (6b′, 6b″) is a part of a parabola, of an ellipsoid, or a free-form curve shape.

12. The reflector according to claim 10, wherein the at least two annular zones comprise an outer annular zone (6b″) and an inner annular zone (6b′) and wherein the outer and inner annular zones (6b′, 6b″) have different slants.

13. The reflector according to claim 1, wherein the at least one reflector surface (6c) is provided with a scattering optic (6c′, 6c″, 14).

14. The reflector according to claim 13, wherein the scattering optic comprises roller-shaped sections or cushion-shaped sections.

15. The reflector according to claim 7, comprising an inner part (18, 18a to 18c) comprising the at least one reflector surface (6, 6a to 6c), wherein the outer reflector part (7, 7a to 7c) is a unitary part with the inner part (18, 18a to 18c).

16. The reflector according to claim 7, wherein the outer reflector part (7, 7a to 7d) and the at least one reflector surface (6, 6a to 6d) are arranged coaxially to one another.

17. The reflector according to claim 7, wherein the outer reflector part (7, 7a to 7d) has a reflector surface located substantially on a conical mantle surface.

18. The reflector according to claim 17, wherein the reflector surface of the outer reflector part (7, 7b) comprises at least two axially sequentially arranged annular zones (10, 10′; 7b′, 7b″) having different slants.

19. The reflector according to clean 17, wherein the at least two annular zones (10, 10′; 7b′, 7b″) of the outer reflector part (7, 7b) in axial section are convexly curved, concavely curved, or concavely and convexly curved reflector surfaces.

20. The reflector according to claim 7, wherein the outer reflector part (7d) has a scattering optic.

21. The reflector according to claim 20, wherein the scattering optic comprises cushion-shaped sections, roller-shaped sections, or cushion-shaped and roller-shaped sections.

22. The reflector according to claim 18, wherein the at least two annular zones (10, 10′; 7b′, 7b″) have identical widths, different widths, or identical and different widths.

23. The reflector according to claim 1, comprising a support (2) on which the illumination element (1, 1a to 1d) is fastened.

24. The reflector according to claim 23, wherein the support (2) is strip-shaped.

25. The reflector according to claim 23, wherein the support (2) is comprised of transparent material.

26. The reflector according to claim 25, wherein the transparent material is a plastic material.

27. The reflector according to claim 1, wherein the illumination element (1, 1a to 1d) is fastened on a lens of a light assembly.

28. The reflector according to claim 1, wherein the outer reflector part (7d) is connected to a lens of a light assembly.

29. The reflector according to claim 28, wherein the outer reflector part (7d) and the lens form a unitary part.

30. The reflector according to claim 1, wherein the illumination element (1, 1a to 1d) is an LED.
